(19) United States
(12) Patent Application Publication
(10) Pub. No.: US 2023/0234095 A1
(43) Pub. Date: Jul. 27, 2023

(54) METHOD FOR PREPARING A METALLIC SURFACE

(71) Applicant: GM GLOBAL TECHNOLOGY OPERATIONS LLC, Detroit, MI (US)

(72) Inventors: Thomas J. Chapaton, Sterling Heights, MI (US); Peter P. Andruskiewicz, IV, Ann Arbor, MI (US)

(73) Assignee: GM GLOBAL TECHNOLOGY OPERATIONS LLC, Detroit, MI (US)

(21) Appl. No.: 17/586,037

(22) Filed: Jan. 27, 2022

(51) Int. Cl. B05D 3/10; B05D 3/12

(52) U.S. Cl. CPC B05D 3/102; B05D 3/12

(57) ABSTRACT

A method for preparing a metallic surface of a device includes executing iterations of a first cleaning regimen and executing iterations of a second cleaning regimen. The first cleaning regimen includes applying a hydrocarbon solvent, e.g., an iso-octane solution, to the metallic surface of the device, executing a first sonication event on the device, and rinsing the metallic surface of the device. The second cleaning regimen includes applying a solution of chlorinated solvent to the metallic surface of the device, executing a second sonication event on the device, and rinsing the metallic surface of the device.

### STATEMENT REGARDING FEDERALLY-SPONSORED RESEARCH OR DEVELOPMENT

This invention was made with Government support under Award No. DE-EE0007754, awarded by U.S. Department of Energy Vehicle Technologies Office. The United States Government has certain rights in this invention.

### INTRODUCTION

Devices have surfaces, e.g., metallic surfaces, that may be coated with non-metallic material to improve performance, increase durability, resist erosion and other forms of deterioration, and otherwise enhance characteristics of the device in-use.

By way of a non-limiting example, a piston of an internal combustion engine may be fabricated from alloys of steel, aluminum, molybdenum, or other materials. A crown of a piston may be advantageously coated with a thermal barrier coating, e.g., a ceramic material, to improve engine combustion, increase exhaust temperatures, and reduce heat losses when compared with a non-coated piston.

A thermal barrier coating may improve engine efficiency by 1-2% in-cylinder, and an additional 2-4% through increased exhaust temperature improving catalyst performance.

Manufacturing of a piston may include forging, machining, and other steps to achieve desired dimensions and surfaces. One process for creating the in-cylinder insulation uses hollow nickel microspheres, sintered together to form a 90-95% porous microsphere matrix. About 50% porosity exists within the microspheres, and the other half is interstitial, between the spheres. This microsphere matrix coating is applied to aluminum or steel components, e.g., by being sintered directly to steel pistons at approximately 850° C. After sintering, the steel pistons can be machined to their final shape and preserved from oxidation by applying a rust inhibitor for shipping/storage. As such, a crown of a piston may be coated with a rust inhibitor during the manufacturing process to prevent deterioration prior to engine assembly. However, applying a rust-inhibiting oil may infiltrate interstitial surfaces on the piston crown, and thus may affect the application of aqueous precursors employed in application of a ceramic material, which may inhibit bonding of the ceramic material to the surface of the piston crown.

There is a need to remove material such as added rust inhibitors from a porous metallic surface, e.g., a microsphere coating on the crown of a piston, prior to coating the crown of the piston with a subsequent ceramic thermal barrier coating.

### SUMMARY

The concepts described herein provide a system and associated process for removing an added material from a metallic surface prior to coating the metallic surface with a thermal barrier coating. In one embodiment, the concepts described herein provide a process for removal of rust inhibitor material from a metallic surface, e.g., the crown of a piston, prior to coating the crown of the piston with a ceramic thermal barrier coating.

The concepts described herein include a method for preparing a metallic surface of a device that includes executing a plurality of iterations of a first cleaning regimen and executing a plurality of iterations of a second cleaning regimen. The first cleaning regimen includes applying a hydrocarbon solvent, e.g., an iso-octane solution, to the metallic surface of the device, executing a first sonication event on the device, and rinsing the surface of the device. The second cleaning regimen includes applying a chlorinated solvent to the metallic surface of the device, executing a second sonication event on the device, and rinsing the surface of the device.

An aspect of the disclosure includes applying the hydrocarbon solvent to the metallic surface of the device by immersing the metallic surface of the device into the hydrocarbon solvent, and executing the first sonication event on the device by sonicating the metallic surface of the device immersed in the hydrocarbon solvent for a first time period.

Another aspect of the disclosure includes sonicating the metallic surface of the device immersed in the hydrocarbon solvent for the first time period by exposing the metallic surface of the device immersed in the hydrocarbon solvent to an ultrasonic wave for between 20 and 60 minutes in duration.

Another aspect of the disclosure includes exposing the device immersed in the hydrocarbon solvent to the ultrasonic wave by exposing the device to a wave frequency between 20 kHz and 120 kHz.

Another aspect of the disclosure includes sonicating the metallic surface of the device and the hydrocarbon solvent by exposing the metallic surface of the device immersed in the hydrocarbon solvent to an ultrasonic wave for the first time period in a room temperature environment.

Another aspect of the disclosure includes applying the hydrocarbon solvent to the metallic surface of the device by immersing the metallic surface of the device into a container containing the hydrocarbon solvent, and immersing the container into a fluidic bath; and executing the first sonication event on the device by exposing the fluidic bath containing the container to an ultrasonic wave for the first time period.

Another aspect of the disclosure includes exposing the fluidic bath containing the container to the ultrasonic wave for between 20 and 60 minutes in duration.

Another aspect of the disclosure includes applying the hydrocarbon solvent to the metallic surface of the device by immersing the metallic surface of the device into a container containing the hydrocarbon solvent, and executing the first sonication event on the device by inserting an ultrasonic probe into the container containing the hydrocarbon solvent and exposing the hydrocarbon solvent to an ultrasonic wave for the first time period via the ultrasonic probe.

Another aspect of the disclosure includes applying the chlorinated solvent to the metallic surface of the device by immersing the metallic surface of the device into the chlorinated solvent, and executing the second sonication event on the device by sonicating the metallic surface of the device immersed in the chlorinated solvent for a second time period.

Another aspect of the disclosure includes sonicating the metallic surface of the device immersed in the chlorinated solvent for second time period by exposing the metallic surface of the device immersed in the chlorinated solvent to an ultrasonic wave for between 20 and 60 minutes in duration.

Another aspect of the disclosure includes sonicating the metallic surface of the device and the chlorinated solvent by exposing the metallic surface of the device immersed in the chlorinated solvent to an ultrasonic wave for between 20 and 60 minutes in duration and in a room temperature environment.

Another aspect of the disclosure includes applying the chlorinated solvent to the metallic surface of the device by immersing the metallic surface of the device into a container containing the chlorinated solvent, and immersing the container into a fluidic bath; and executing the second sonication event on the device by exposing the fluidic bath containing the container to an ultrasonic wave for a second time period.

Another aspect of the disclosure includes applying the chlorinated solvent to the metallic surface of the device by immersing the metallic surface of the device into a container containing the chlorinated solvent; and executing the second sonication event on the device by inserting an ultrasonic probe into the container containing the chlorinated solvent and exposing the chlorinated solvent to an ultrasonic wave for the second time period via the ultrasonic probe.

Another aspect of the disclosure includes the first cleaning regimen being executed multiple times prior to executing the second cleaning regimen.

Another aspect of the disclosure includes the second cleaning regimen being executed multiple times.

Another aspect of the disclosure includes a method for removing a rust-inhibiting coating from a metallic surface of a device by executing a first cleaning regimen and executing a second cleaning regimen. The first cleaning regimen includes immersing the metallic surface of the device into a hydrocarbon solvent, executing a first sonication event on the device for a first time period, and rinsing the surface of the device. The second cleaning regimen includes immersing the metallic surface of the device into chlorinated solvent, executing a second sonication event on the device for a second time period, and rinsing the surface of the device.

Another aspect of the disclosure includes executing the first sonication event on the device by exposing the hydrocarbon solvent and the metallic surface of the device immersed in the hydrocarbon solvent to an ultrasonic wave for the first time period.

Another aspect of the disclosure includes exposing the hydrocarbon solvent and the metallic surface of the device immersed in the hydrocarbon solvent to an ultrasonic wave for the first time period by immersing the metallic surface of the device into a container containing the hydrocarbon solvent, and immersing the container into a fluidic bath. Executing the first sonication event on the device includes exposing the fluidic bath containing the container to an ultrasonic wave for the first time period.

Another aspect of the disclosure includes exposing the hydrocarbon solvent and the metallic surface of the device immersed in the hydrocarbon solvent to an ultrasonic wave for the first time period by immersing the metallic surface of the device into a container containing the hydrocarbon solvent, and inserting an ultrasonic probe into the container. Executing the first sonication event on the device includes exposing the hydrocarbon solvent to an ultrasonic wave via the ultrasonic probe for the first time period.

Another aspect of the disclosure includes the first cleaning regimen being executed multiple times prior to executing the second cleaning regimen, and the second cleaning regimen being executed multiple times.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates a process flow diagram for a method for preparing a metallic surface of a device, in accordance with the disclosure.

FIG. 2 schematically illustrates elements of a system for executing the method described with reference to FIG. 1 for preparing the metallic surface of a device, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments can be practiced without some of these details. Moreover, for the purpose of clarity, certain technical material that is understood in the related art has not been described in detail to avoid unnecessarily obscuring the disclosure. For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein. The following detailed description is merely exemplary in nature and is not intended to limit the application and uses.

Exemplary embodiments may be described herein in terms of functional and/or logical block components and various processing steps. It should be appreciated that such block components may be realized by any number, combination or collection of mechanical and electrical hardware, software, and/or firmware components configured to perform the specified functions. For the sake of brevity, conventional components and techniques and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the disclosure. The use of ordinals such as first, second and third does not necessarily imply a ranked sense of order, but rather may only distinguish between multiple instances of an act or structure.

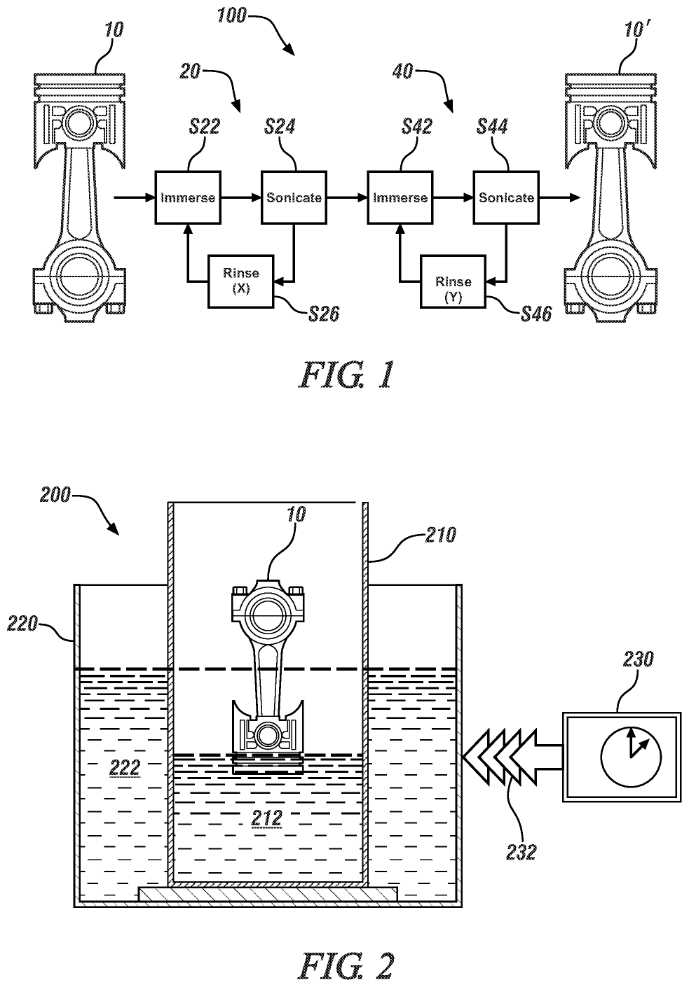

Referring to the drawings, wherein like reference numerals correspond to like or similar components throughout the several Figures, FIG. 1 schematically illustrates a process flow diagram for a method 100 for preparing a metallic surface of a device 10, and FIG. 2 schematically illustrates elements of a system 200 for executing the method 100 for preparing the metallic surface of device 10. The method 100 includes executing a first cleaning regimen 20 followed by executing a second cleaning regimen 40 to remove one or more additive materials and/or contaminants from the metallic surface of the device 10. In one embodiment, the method 100 removes a manufacturing additive in the form of a rust-inhibiting coating from a metallic surface of a device, such as removing a rust-inhibiting oil from a metallic crown surface of a piston for an internal combustion engine. The removing of the rust-inhibiting oil from the metallic crown surface of the piston is advantageously executed immediately prior to applying a ceramic sealing layer or applying a thermal barrier coating to the surface of the piston crown to enhance bonding of ceramic material thereto.

FIG. 2 schematically illustrates elements of the system 200, and includes a container 210 for immersing the device 10 in a solvent 212, a bath 220 containing an aqueous solution 222, and an ultrasonic generator 230. One embodiment of the system 200 may be employed for executing the first cleaning regimen 20, and another embodiment of the system 200 may be employed for executing the second cleaning regimen 40. During execution of the first cleaning regimen 20, the solvent 212 a hydrocarbon solvent, e.g., iso-octane. During execution of the second cleaning regimen 40, the solvent 212 is a chlorinated solvent, e.g., dichloromethane.

Dichloromethane (DCM or methylene chloride) is an organochloride compound having the formula CH₂Cl₂.

In an alternative embodiment, the ultrasonic generator 230 is in the form of an ultrasonic probe (not shown) that is inserted into the aqueous solution 222 contained in the bath 220.

In an alternative embodiment, the ultrasonic generator 230 is in the form of an ultrasonic probe (not shown) that is inserted into the solvent 212 contained in the container 210.

When the system 200 is employed for executing the first cleaning regimen 20, the solvent 212 contained in the container 210 for immersing the device 10 is the hydrocarbon solvent, e.g., an iso-octane solution, and the bath 220 contains an aqueous solution 222. When the system 200 is employed for executing the second cleaning regimen 40, the solvent 212 contained in the container 210 for immersing the device 10 contains the chlorinated solvent solution, and the bath 220 contains the aqueous solution 222.

The ultrasonic generator 230 is able to generate and transfer ultrasonic vibrational energy to the aqueous solution 222 in the bath 220 for a predefined time period, which is transferred to the solvent 212 contained in the container 210. In one embodiment, the ultrasonic vibration is in a frequency range of 20 kHz to 120 kHz, and the predefined time period is in a range between 20 and 60 minutes in duration. The ultrasonic vibration frequency range and time period of the first cleaning regimen 20 are application-specific, and advantageously based upon an analysis of the metallic surface of the device 10 indicating the efficacy of removal of one or more additive materials and/or contaminants therefrom.

Referring again to FIG. 2, the first cleaning regimen 20 includes immersing at least the metallic surface of the device 10 into the hydrocarbon solvent (S22), executing a first sonication event on the device 10 for a first time period (S24), and rinsing the surface of the device 10 with a fresh quantity of the hydrocarbon solvent (S26). The steps S22, S24 and S6 of the first cleaning regimen 20 are repeated a quantity of X iterations. In one embodiment, there are three iterations of the steps S22, S24 and S26 of the first cleaning regimen 20 prior to proceeding to the second cleaning regimen 40. Alternatively, there can be 1, 2, 4, 5, 6 or another quantity of iterations of the steps S22, S24 and S26 of the first cleaning regimen 20 prior to proceeding to the second cleaning regimen 40. The quantity of X iterations of the first cleaning regimen 20 is application-specific, and advantageously based upon an analysis of the metallic surface of the device 10 indicating the efficacy of removal of one or more additive materials and/or contaminants therefrom. In one embodiment, the steps S22, S24 and S26 of the first cleaning regimen 20 and the steps S42, S44 and S46 of the second cleaning regimen 40 are executed in a room temperature environment, e.g., at or about 20C. In one embodiment, the first time period is between 20 minutes and 60 minutes in duration.

Sonication refers to the process of applying sound energy to agitate particles or discontinuous fibers in a liquid. Ultrasonic frequencies, i.e., frequencies greater than 20 kHz, are employed, so the process may also be known as ultrasonication. Sonication can be conducted using either an ultrasonic bath or an ultrasonic probe, i.e., a sonicator.

The first cleaning regimen 20 includes immersing at least the metallic surface of the device 10 into a bath containing a hydrocarbon solvent (S22), wherein the hydrocarbon solvent may be an iso-octane material in one embodiment. Alternatively, this can instead include immersing at least the metallic surface of the device 10 into a bath containing another solvent (S22).

The first cleaning regimen 20 includes executing the first sonication event on the device 10 for the first time period (S24) by operating the ultrasonic generator 230 to generate and transfer ultrasonic vibration to the hydrocarbon solvent in the bath 220. The ultrasonic vibration frequency range and time period of the first cleaning regimen 20 are application-specific, and advantageously based upon an analysis of the metallic surface of the device 10 indicating the efficacy of removal of one or more additive materials and/or contaminants therefrom.

Subsequent to the first sonication event (S24) the first cleaning regimen 20 includes rinsing the surface of the device (S26) with a fresh quantity of the hydrocarbon solvent, and repeating the process steps S22, S24 and S26 with fresh quantities of the solvent 212 in the form of the hydrocarbon solvent in the container 210. After X iterations of process steps S22, S24 and S26 of the first cleaning regimen 20, the method 100 proceeds to execute the second cleaning regimen 40.

The second cleaning regimen 40 includes immersing the metallic surface of the device 10 into the container 210 containing the solvent 212 in the form of a chlorinated solvent, e.g., dichloromethane (S42), executing a second sonication event on the device 10 for a second time period (S44), and rinsing the surface of the device 10 with a fresh quantity of the chlorinated solvent (S46). The steps S42, S44 and S46 of the second cleaning regimen 40 are repeated a quantity of Y iterations. In one embodiment, there are three iterations of the steps S42, S44 and S46 of the second cleaning regimen 40. Alternatively, there can be 1, 2, 4, 5, 6 or another quantity of iterations of the steps S42, S44 and S46 of the second cleaning regimen 40. The quantity of Y iterations of the second cleaning regimen 40 is application-specific, and advantageously based upon an analysis of the metallic surface of the device 10 indicating the efficacy of removal of one or more additive materials and/or contaminants therefrom. In one embodiment, the second time period is between 20 minutes and 60 minutes in duration.

The second cleaning regimen 40 includes immersing at least the metallic surface of the device 10 into the container 210 containing the solvent 212 in the form of chlorinated solvent (S42). In one embodiment, this includes immersing at least the metallic surface of the device 10 into container 210 containing the chlorinated solvent, e.g., dichloromethane (S42).

The second cleaning regimen 40 includes executing the second sonication event on the device 10 for the first time period (S44) by operating the ultrasonic generator 230 to generate and transfer ultrasonic vibration to the aqueous solution 222 in the bath 220. The ultrasonic vibration frequency range and the second time period of the second cleaning regimen 40 are application-specific, and advantageously based upon an analysis of the metallic surface of the device 10 indicating the efficacy of removal of one or more additive materials and/or contaminants therefrom.

Subsequent to the second sonication event (S44) the second cleaning regimen 40 includes rinsing the surface of the device with a fresh quantity of the chlorinated solvent, e.g., dichloromethane (S46), and repeating the process steps S42, S44 and S46. After multiple iterations of the process steps S42, S44 and S46, the method 100 ends, and a final workpiece 10′ is delivered to a subsequent step. In one embodiment, the steps S22, S24 and S26 of the first cleaning regimen 20 and the steps S42, S44 and S46 of the second cleaning regimen 40 are executed in a room temperature environment, e.g., at or about 20C. In one embodiment, the first time period and the second time period are between 20 minutes and 60 minutes in duration.

The first time period and the second time period are application-specific, and advantageously based upon an analysis of the metallic surface of the device 10 indicating the efficacy of removal of one or more additive materials and/or contaminants therefrom. The temperatures of the first cleaning regimen 20 and the second cleaning regimen 40 are application-specific, and advantageously based upon an analysis of the metallic surface of the device 10 indicating the efficacy of removal of one or more additive materials and/or contaminants therefrom.

The flows, methods, and processes described below and in the accompanying figures are merely representative of functions that may be performed in particular embodiments. In other embodiments, additional functions may be performed in the flows, methods, and processes. Various embodiments of the present disclosure contemplate any suitable signaling mechanisms for accomplishing the functions described herein. Some of the functions illustrated herein may be repeated, combined, modified, or deleted within the flows, methods, and processes where appropriate. Additionally, functions may be performed in any suitable order within the flows, methods, and processes without departing from the scope of particular embodiments.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A method for preparing a metallic surface of a device, the method comprising:
executing a plurality of iterations of a first cleaning regimen, wherein each of the plurality of iterations includes:
applying a hydrocarbon solvent to the metallic surface of the device,
executing a first sonication event on the device, and
rinsing the metallic surface of the device; and
executing a plurality of iterations of a second cleaning regimen, wherein each of the plurality of iteration includes:
applying a chlorinated solvent to the metallic surface of the device,
executing a second sonication event on the device, and
rinsing the metallic surface of the device.

2. The method of claim 1, wherein applying the hydrocarbon solvent to the metallic surface of the device comprises immersing the metallic surface of the device into the hydrocarbon solvent, and wherein executing the first sonication event on the device comprises sonicating the metallic surface of the device immersed in the hydrocarbon solvent for a first time period.

3. The method of claim 2, wherein sonicating the metallic surface of the device immersed in the hydrocarbon solvent for the first time period comprises exposing the metallic surface of the device immersed in the hydrocarbon solvent to an ultrasonic wave for a time period between 20 and 60 minutes in duration.

4. The method of claim 3, wherein exposing the device immersed in the hydrocarbon solvent to the ultrasonic wave comprises exposing the device to a wave frequency between 20 kHz and 120 kHz.

5. The method of claim 2, further comprising removing the metallic surface of the device from the hydrocarbon solvent and rinsing the metallic surface of the device with a fresh quantity of the hydrocarbon solvent;
wherein sonicating the metallic surface of the device and the hydrocarbon solvent for the first time period further comprises exposing the metallic surface of the device immersed in the hydrocarbon solvent to an ultrasonic wave for a time period between 20 and 60 minutes in duration in a room temperature environment.

6. The method of claim 1, wherein applying the hydrocarbon solvent to the metallic surface of the device comprises immersing the metallic surface of the device into a container containing the hydrocarbon solvent, and immersing the container into a fluidic bath containing an aqueous solution; and wherein executing the first sonication event on the device comprises exposing the fluidic bath containing the container to an ultrasonic wave for a first time period.

7. The method of claim 6, comprising exposing the fluidic bath containing the container to the ultrasonic wave for between 20 and 60 minutes in duration.

8. The method of claim 1, wherein applying the hydrocarbon solvent to the metallic surface of the device comprises immersing the metallic surface of the device into a container containing the hydrocarbon solvent; and wherein executing the first sonication event on the device comprises inserting an ultrasonic probe into the container containing the hydrocarbon solvent and exposing the hydrocarbon solvent to an ultrasonic wave via the ultrasonic probe.

9. The method of claim 1, wherein applying the chlorinated solvent to the metallic surface of the device comprises immersing the metallic surface of the device into the chlorinated solvent, and wherein executing the second sonication event on the device comprises sonicating the metallic surface of the device immersed in the chlorinated solvent for a second time period.

10. The method of claim 9, wherein sonicating the metallic surface of the device immersed in the chlorinated solvent for the second time period comprises exposing the metallic surface of the device immersed in the chlorinated solvent to an ultrasonic wave for between 20 and 60 minutes in duration.

11. The method of claim 9, wherein sonicating the metallic surface of the device and the chlorinated solvent for the second time period further comprises exposing the metallic surface of the device immersed in the chlorinated solvent to an ultrasonic wave for between 20 and 60 minutes in duration and in a room temperature environment.

12. The method of claim 1, wherein applying the chlorinated solvent to the metallic surface of the device comprises immersing the metallic surface of the device into a container containing the chlorinated solvent, and immersing the container into a fluidic bath; and wherein executing the second sonication event on the device comprises exposing the fluidic bath containing the container to an ultrasonic wave for a second time period.

13. The method of claim 1, wherein applying the chlorinated solvent to the metallic surface of the device comprises immersing the metallic surface of the device into a container containing the chlorinated solvent; and wherein executing the second sonication event on the device comprises inserting an ultrasonic probe into the container containing the chlorinated solvent and exposing the chlorinated solvent to an ultrasonic wave via the ultrasonic probe.

14. The method of claim 1, wherein the plurality of iterations of the first cleaning regimen is executed prior to executing the second cleaning regimen.

15. A method for removing a rust-inhibiting coating from a metallic surface of a device, the method comprising:
executing a first cleaning regimen, including:
immersing the metallic surface of the device into a hydrocarbon solvent,
executing a first sonication event on the device for a first time period, and
rinsing the metallic surface of the device; and
executing a second cleaning regimen, including:
immersing the metallic surface of the device into a chlorinated solvent,
executing a second sonication event on the device for a second time period, and
rinsing the metallic surface of the device.

16. The method of claim 15, wherein executing the first sonication event on the device comprises exposing the hydrocarbon solvent and the metallic surface of the device immersed in the hydrocarbon solvent to an ultrasonic wave for the first time period.

17. The method of claim 15, wherein exposing the hydrocarbon solvent and the metallic surface of the device immersed in the hydrocarbon solvent to an ultrasonic wave for the first time period comprises immersing the metallic surface of the device into a container containing the hydrocarbon solvent, and immersing the container into a fluidic bath containing an aqueous solution; and wherein executing the first sonication event on the device comprises exposing the aqueous solution in the fluidic bath to an ultrasonic wave for the first time period.

18. The method of claim 15, wherein exposing the hydrocarbon solvent and the metallic surface of the device immersed in the hydrocarbon solvent to an ultrasonic wave for the first time period comprises immersing the metallic surface of the device into a container containing the hydrocarbon solvent, and inserting an ultrasonic probe into the container; and wherein executing the first sonication event on the device comprises exposing the hydrocarbon solvent to an ultrasonic wave via the ultrasonic probe for the first time period.

19. The method of claim 15, wherein the first cleaning regimen is executed multiple times prior to executing the second cleaning regimen.

20. The method of claim 15, wherein the second cleaning regimen is executed multiple times subsequent to executing the first cleaning regimen.
